(19) United States
(12) Patent Application Publication
(10) Pub. No.: US 2018/0194423 A1
(43) Pub. Date: Jul. 12, 2018

(54) IMPROVED THREE-WHEELED SCOOTER

(71) Applicant: HL CORP (SHENZHEN), Shenzhen, Guangdong (CN)

(72) Inventor: Cheng-Neng Fan, Shenzhen, Guangdong (CN)

(21) Appl. No.: 15/741,492

(22) PCT Filed: Aug. 13, 2016
(86) PCT No.: PCT/CN2016/000448

§ 371 Date: Jan. 2, 2018

(30) Foreign Application Priority Data
Aug. 24, 2015 (CN) 201520639459.6

(51) Int. Cl. B62K 5/08; B62K 5/06

(52) U.S. Cl. CPC B62K 5/08; B62K 5/06

(57) ABSTRACT

An improved three-wheeled scooter includes a head tube (10), a steering tube (11), a handle (12), a front wheel (13), a carrier (14), and rear wheels (16). The carrier (14) is mounted to a rear side of the head tube (10). The rear wheels (16) are mounted to opposite sides of a rear end of the carrier (14). The front wheel (13) is mounted to a bottom end of the steering tube (11). A rotation shaft (131) of the front wheel is located behind a centerline (Y) of the head tube. The handle (12) is mounted to a top end of the steering tube (11), and then extends up in an inclination angle about 75-90 degrees. The carrier includes left and right carrier poles (141) which are shortened. The front wheel (13) and the rear wheels (16) are substantially arranged in an equilateral triangle. The front wheel (13) can do S-shaped swing in a great angle, thereby improving the sliding speed of the three-wheeled scooter.

### TECHNICAL FIELD OF THE INVENTION

The present invention relates to improved three-wheeled scooters, and more specifically to an improved three-wheeled scooter which is simply set and simple in operation, has different operation modalities thereby obtaining effects of improving use fun and entertainment, and is in accordance with actual practicability, novelty, and creativity.

### BACKGROUND OF THE INVENTION

Current scooters arranged in triangle and moving scooter bodies through a mode of left-and-right swing are varied, such as scooters disclosed in U.S. Pat. Nos. 6,499,751 B1, 6,517,093B2, 6,554,302B1, 6,827,358B2, and 6,976,687B2. Structures of the scooters in the above-mentioned patents are mostly similar to structures shown in FIG. 1 which includes a head tube 10, a steering tube 11 rotatably mounted in the head tube 10, a handle 12 and a front wheel 13 respectively mounted to a top end and a bottom end of the steering tube 11, left and right carrier poles 15 located behind the head tube 10 and respectively mounted to opposite sides of a bottom end of the head tube 10 with front ends, rear wheels 16 respectively mounted to rear ends of the left and right carrier poles 15, and carrier plates 17 respectively mounted to the left and right carrier poles 15. After a user stands on the carrier plates 17 of the left and right carrier poles 15 with his feet and holds the handle 12 with his hands, the user can swing the handle 12 left and right, wriggle his body, or alternately apply forces on the corresponding carrier plates 17, to operate the scooter. The front wheel 13 rolls forward in an S-shaped path, with the handle 12 swinging left and right. The left and right rear wheels 16 accordingly rotate, thereby obtaining the purpose of assisting in moving the whole scooter.

According to the above-mentioned scooter, the left and right rear wheels 16 are mounted to the rear ends of the corresponding carrier poles 15 in a mode of non-swing, and the head tube 10 is arranged in an inclination angle about 80 degrees which is slightly greater than an inclination angle about 75 degrees of a head tube of a general scooter in order to meet ergonomic operation needs. A distance between the left and right carrier plates 17 is approximately equal to a width of a natural feet span of a user. After the steering tube 11 is rotatably mounted in the head tube 10 and extends up and down in a same angle equal to the head tube 10, lengths of the left and right carrier poles 15 are designed greater in order to avoid the inclined steering tube 11 and the handle 12 hindering and interfering with the body of the user. When the user stands on the carrier plates 17 of the corresponding carrier poles 15 with his feet distancing from each other for a natural open-width and holds the handle 12 with his hands, the body of the user can keep appropriate distances from the steering tube 11 and the handle 12, for facilitating operating the scooter. That is to say, in order to make the operation of the three-wheeled scooter more smooth, the front wheel 13 and the left and right rear wheels 16 are arranged in a triangle, which substantially has a modality of an isosceles triangle with a length between the front wheel 13 and each of the left and right rear wheels 16 being longer, and while a length between the left and right wheels 16 being shorter.

Admittedly, the above-mentioned three-wheeled scooter arranged in an isosceles triangle can provide a good exercise effect for users. However, in practice, the following situations may be generated.

Firstly, because the lengths of the left and right carrier poles 15 must be designed to be longer, a volume of the scooter will be enlarged, and therefore, situations of a great package volume, occupying spaces, and inconvenient storage will be generated.

Secondly, because the inclination angle of the head tube 10 and the steering tube 11 rotatably mounted in the head tube 10 is approximately vertical, a swing angle of the front wheel 13 mounted to the bottom end of the steering tube 11 will be smaller accordingly when the hands of the user swing the handle 12 mounted to the steering tube 11 left and right. Thus, the front wheel 13 will roll in an S-shaped path which has a smaller swing angle, which will not only influence a running speed of the scooter, but also increase the load of the operation of the hands.

Thirdly, referring to FIG. 2, because the distances from the front wheel 13 to the left and right rear wheels 16 are the same and are greater than the distance between the left and right rear wheels 16, when the scooter takes one of the rear wheels 16 as a center to swing and travel, the other rear wheel 16 and the front wheel 13 cannot travel in a same circumference and do individual circular motions in the situation of having a very great semi-diameter difference X because of different radius of gyration of the other rear wheel 16 and the front wheel 13. However, because the left and right rear wheels 16 are steadily mounted to the rear ends of the corresponding carrier poles 15 in the mode of non-swing and front ends of the carrier poles 15 are fixed to the head tube 10, when the rear wheels 16 located at the rear ends of the carrier poles 15 and the front wheel 13 located below the head tube 10 that is at the front ends of the carrier poles 15 do individual circular motions with different radius, mutual restraint and large displacement friction will be produced inevitably, and then, situations that the wheels are prone to wear and operations of the scooter are more laborious will be produced.

In view of the shortcomings of the above-mentioned current three-wheeled scooter, the present disclosure provides an improved three-wheeled scooter to overcome the shortcomings of the current scooter to make the scooter more practical.

### SUMMARY OF THE INVENTION

An object of the present disclosure is to provide an improved three-wheeled scooter, which can overcome the above-mentioned shortcomings, allow operations of the three-wheeled scooter more smooth and laborsaving, and allow the scooter to have different operation modalities, thereby obtaining effects of improving use fun and leisure and entertainment.

To obtain the above-mentioned object, the present disclosure arranges front and rear wheels of the scooter in an equilateral triangle to shorten left and right carrier poles, arranges a head tube in an inclination angle about 55-70 degrees, arranges a rotation shaft of the front wheel behind a centerline of the head tube after rotatably mounting a bottom end of a steering tube to the head tube, arranges the steering tube upward in an inclination angle about 75-90 degrees after rotatably mounting the bottom end of the steering tube to the head tube, and allows a handle located at a top end of the scooter to extend forward. Accordingly, after a user stands on pedals of corresponding carrier poles with his feet, a body center of gravity of the user will be adjacent to the front wheel automatically and the steering tube will not interfere with the body of the user. When hands of the user swing the handle left and right, a force arm is automatically formed between the handle located in front of a top end of the steering tube and the front wheel located at the bottom end of the head tube. Therefore, operation of the hands not only is laborsaving and smooth but also can make swing amplitude be more expanded, and then, the front wheel can do an S-shaped swing in a greater angle to obtain effects of improving a traveling speed and showing different operation modalities.

The object and technical problems to be resolved of the present disclosure are achieved through the following technical solutions. The present disclosure provides an improved three-wheeled scooter including a head tube arranged in an inclination angle about 55-70 degrees, a steering tube rotatably mounted to the head tube, a front wheel mounted to a bottom end of the steering tube, a handle mounted to a top end of the steering tube, a carrier mounted to a rear side of the head tube, and left and right rear wheels respectively mounted to opposite sides of a rear end of the carrier. A portion of the steering tube adjacent to a bottom end is inclined upward in an inclination angle about 75-90 degrees after the bottom end of the steering tube is rotatably mounted to the head tube.

The object and technical problems to be resolved of the present disclosure can be further achieved through the following technical measures.

In the above-mentioned improved three-wheeled scooter, a rotation shaft of the front wheel is eccentrically located behind a bottom end of a centerline of the head tube.

In the above-mentioned improved three-wheeled scooter, the handle extends forward from the steering tube.

In the above-mentioned improved three-wheeled scooter, the left and right rear wheels are mounted to the opposite sides of the rear end of the carrier in a mode of non-swing.

In the above-mentioned improved three-wheeled scooter, the carrier includes left and right carrier poles, pedals are respectively mounted to the left and right carrier poles.

In the above-mentioned improved three-wheeled scooter, the carrier includes left and right carrier poles, the rear wheels are respectively mounted to rear ends of the left and right carrier poles.

In the above-mentioned improved three-wheeled scooter, the front wheel mounted to the bottom end of the steering tube and the rear wheels mounted to the opposite sides of the rear end of the carrier are substantially arranged in an equilateral triangle.

According to the above-mentioned technical solutions, the present disclosure has at least the following advantages.

Firstly, the arrangement is simple, and is economical.

Secondly, it is easy and convenient to operate and use the scooter, and has implement convenience.

Thirdly, it allows the use of the three-wheeled scooter to have different operation modalities, thereby obtaining the effects of improving the use fun and leisure and entertainment.

To enable the examiner to further understand and agree on the objects, the features, and the effects of the present disclosure, the present disclosure is detailed described cooperating with attached drawings and the embodiments.

### BRIEF DESCRIPTION OF THE DRAWINGS

FIG. 1 is a schematic, isometric view of a related-art three-wheeled scooter.

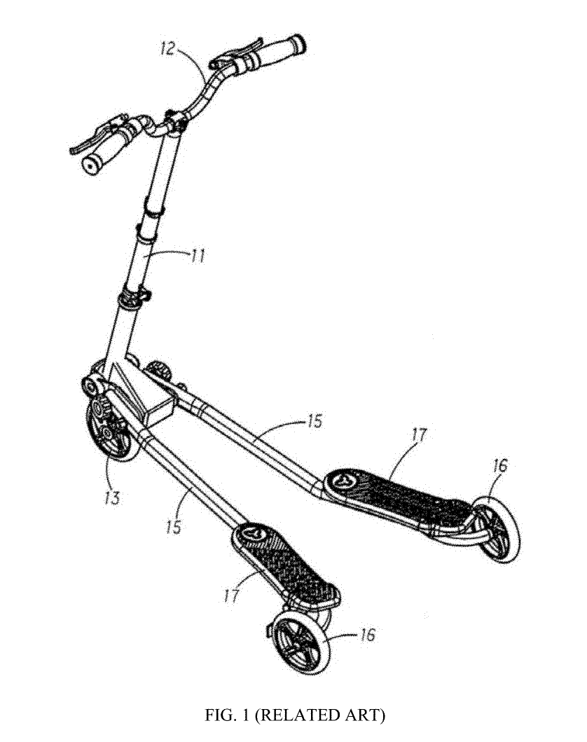

FIG. 2 is a schematic view showing operation of front and rear wheels of the related-art three-wheeled scooter.

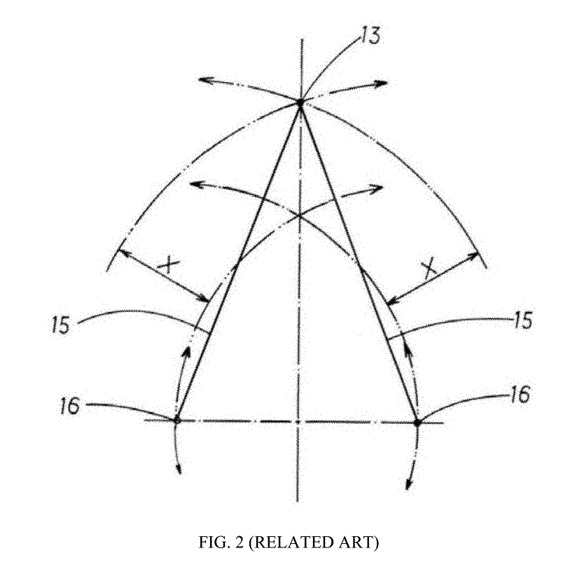

FIG. 3 is a schematic, isometric view of an embodiment of a three-wheeled scooter of the present disclosure.

FIG. 4 is an elevational view of FIG. 3.

FIG. 5 is a top plan view of FIG. 3.

FIG. 6 is a schematic view of the present disclosure, showing operation of front and rear wheels.

### DESCRIPTION OF THE MAIN COMPONENT SYMBOLS IS LISTED BELOW

D: Distance X: Semi-diameter difference

Y: Centerline θ: Inclination angle

α: Inclination angle 10: Head tube

11: Steering tube 111: Second steering tube

12: Handle 13: Front wheel

131: Rotation shaft 14: Carrier

141: Carrier pole 142: Pedal

15: Carrier pole 16: Rear wheel

17: Carrier plate

### DETAILED DESCRIPTION OF THE INVENTION

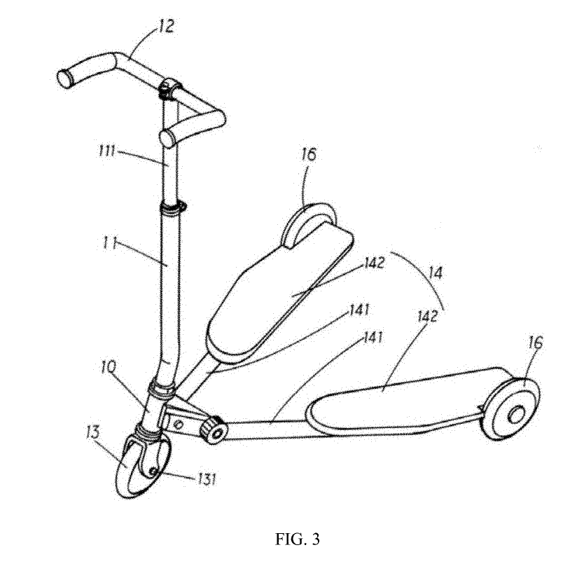

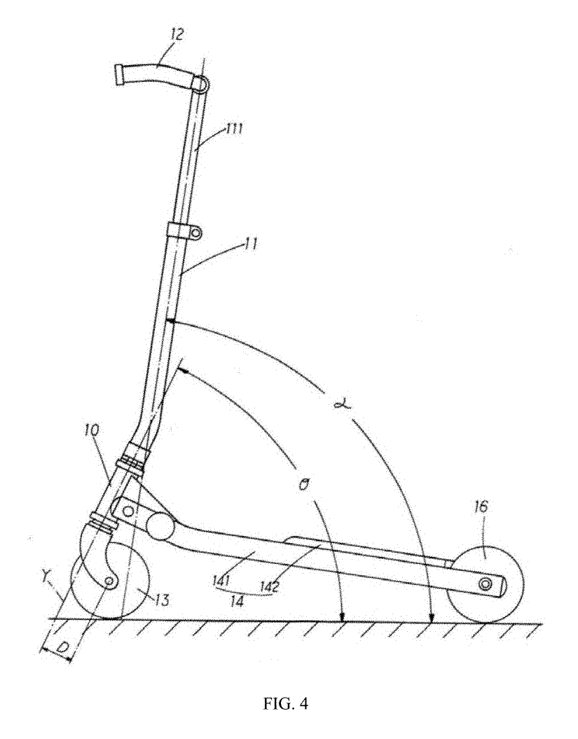

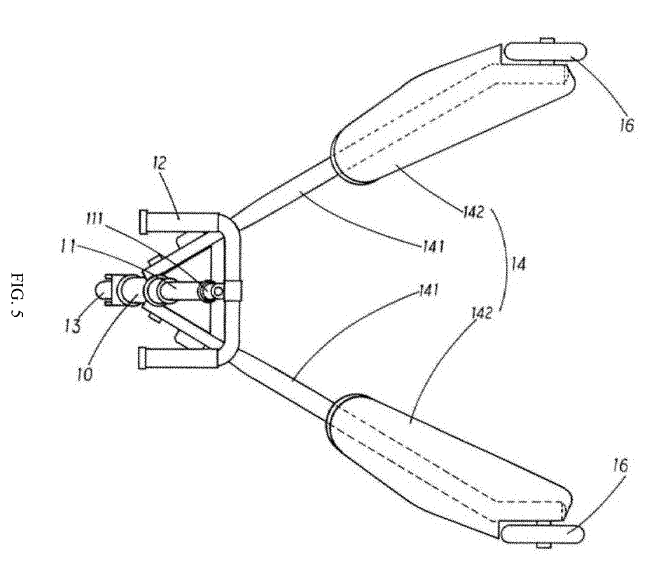

Referring to FIGS. 3-5, an embodiment of the present disclosure provides an improved three-wheeled scooter, which includes a head tube 10 arranged in an inclination angle about 55-70 degrees, a steering tube 11 rotatably mounted to the head tube 10, a front wheel 13 mounted to a bottom end of the steering tube 11, a handle 12 extending forward from a top end of the steering tube 11, a carrier 14 mounted to a rear side of the head tube 10 for feet of a user straddling, and two rear wheels 16 mounted to opposite sides of a rear end of the carrier 14 in a mode of non-swing. A rotation shaft 131 of the front wheel is eccentrically located behind a bottom end of a centerline Y of the head tube 10 with a distance D. A portion adjacent to a bottom end of the steering tube 11 is inclined upward in an inclination angle α about 75-90 degrees after the bottom end of the steering tube 11 is rotatably mounted to the head tube 10. The left and right rear heels 16 and the front wheel 13 cooperate to form three points to the ground to support the whole scooter. The carrier 14 includes left and right carrier poles 141, and left and right pedals 142. Front ends of the left and right carrier poles 141 are mounted to the head tube 10. The left and right pedals 142 are respectively mounted to the corresponding carrier poles 141. The left and right rear wheels 16 and the front wheel 13 are substantially arranged in an equilateral triangle.

According to the above-mentioned, the steering tube 11 is rotatably mounted with a second steering tube 111. The second steering tube 111 is adjustable to move up or down relative to the steering tube 11 according to user's needs. The handle 12 is mounted to a top end of the second steering tube 111.

According to the above-mentioned, to make the front wheel 13 and the left and right rear wheels 16 be substantially arranged in an equilateral triangle, and to allow the feet of the user to straddle and apply force on the carrier 14, the left and right carrier poles 141 the carrier 14 are designed to be shorter.

According to the above-mentioned of the present disclosure, because the front wheel 13 and the left and right rear wheels 16 are substantially arranged in an equilateral triangle to allow the feet of the user to naturally straddle and apply force on the carrier 14, in the case of the left and right carrier poles 141 of the carrier 14 being designed to be shorter, the body of the user will automatically move forward to allow a center of gravity of the user to be adjacent to the front wheel 13 when the user operates the scooter and naturally straddles the carrier 14 to stand on the corresponding pedals 141 with the feet. Because a portion adjacent to a bottom end of the steering tube 11 is inclined upward in the inclination angle α about 75-90 degrees after the bottom end of the steering tube 11 is rotatably mounted to the head tube 10, although the body of the user may move forward when the feet of the user straddle the carrier 14, the steering tube 11 arranged in the inclination angle about 75-90 degrees can keep a great space with the body of the user, and the steering tube 11 and the body of the user will not interfere with each other. Because the head tube 10 is arranged in the inclination angle θ about 55-70 degrees, the bottom end of the steering tube 11 is arranged in the same inclination angle with the head tube 10 after being rotatably mounted to the head tube 10, and the front wheel 13 is eccentrically arranged behind the bottom end of the centerline Y of the head tube 10 with the distance D, when the hands of the user swing the handle 12 mounted to the top end of the steering tube 11 left and right, the front wheel 13 mounted to the bottom end of the steering tube 11 naturally takes the head tube 10 as a rotation axis to swing and travel in a great-angled and S-shaped mode, which not only obtains an effect of improving a speed of moving the scooter, but also allows the handle 12 and the steering tube 11 to do large rotary swing, thereby obtaining effects of sports, fitness, and leisure and entertainment with different forms. Furthermore, because the handle 12 mounted to the steering tube 11 extends forward to form a force arm together with the rotation shaft 131 of the front wheel 13, when the hands of the user hold the handle 12 to do rotary swing, the operation of the scooter is more smooth and natural, and effects of expanding swing amplitude and being labor-saving can be obtained.

According to the above-mentioned, when the hands of the user operate the handle 12 of the scooter to do rotary swing left and right and make the front wheel 13 to swing and travel in a great-angled and S-shaped mode, the user can also simultaneously applies force on the carrier 14 through a mode of wiggling his body or through another mode of alternately applying force on the carrier 14 through his feet, to allow the left and right rear wheels 16 to be alternately stressed to roll, thereby obtaining the effect of auxiliary moving the scooter body.

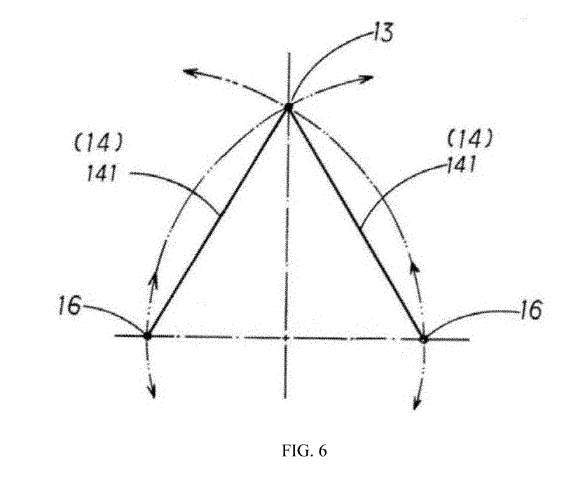

Referring to FIG. 6, because the front wheel 13 and the left and right rear wheels 16 are substantially arranged in an equilateral triangle to make a distance from the front wheel 13 to each of the left and right rear wheels 16 be substantially equal to a distance between the left and right rear wheels 16, when the feet of the user respectively apply forces on the corresponding carrier poles 141 of the carrier 14 to take one of the rear wheels 16 as a center of a circle to make the scooter swing and travel in an S-shaped path, the other rear wheel 16 and the front wheel 13 inevitably travel on the same circle because of the same radius of gyration. Therefore, because the front wheel 13 and the rear wheel 16 respectively located at the opposite ends of the corresponding carrier pole 141 can travel on the same circle, the roll displacement of the front wheel 13 and the rear wheel 16 is inevitably smooth and friction forces of the front wheel 13 and the rear wheel 16 are small, thereby prolonging the life of the scooter and allowing the scooter to have better and labor-saving sliding effects.

According to the use requirements, the scooter of the present disclosure can be mounted with variety brake apparatus, such as hand brake apparatus or foot brake apparatus (not shown), to brake the front wheel or the rear wheels. The brake apparatus is similar to an ordinary bake apparatus, so the brake apparatus is not repeated in detail.

Because the front wheel 13 and the left and right rear wheels 16 are substantially arranged in an equilateral triangle, which causes the left and right carrier poles 141 of the carrier 14 to be shorter to be in accordance with Ergonomics of the feet naturally opening to straddle and applying forces on the scooter, in terms of implementation, the left and right carrier poles 141 are designed to be shorter, which can obtain effects of reducing a volume of the scooter, being easy to be packaged, carried, and contained, and being space-saving.

The above-mentioned only is embodiments of the present disclosure, and is not intended to be a limitation of the present disclosure in any way. Even though embodiments of the present disclosure have been set forth in the foregoing description, it is not intended to limit the present disclosure, those of ordinary skill in the art may, of course, make equivalent embodiments with some minor changes or modifications. For those of ordinary skill in the art, any simple amendments, equivalent changes, and modifications of these embodiments without departing from the contents of the present disclosure may fall within the scope of the technical solutions of the present disclosure.

What is claimed is:

1. An improved three-wheeled scooter, comprising:
a head tube arranged in an inclination angle about 55-70 degrees;
a steering tube rotatably mounted to the head tube;
a front wheel mounted to a bottom end of the steering tube;
a handle mounted to a top end of the steering tube;
a carrier mounted to a rear side of the head tube; and
left and right rear wheels respectively mounted to opposite sides of a rear end of the carrier;
wherein a portion adjacent to the bottom end of the steering tube is inclined upward in an inclination angle about 75-90 degrees after the bottom end of the steering tube is rotatably mounted to the head tube.

2. The improved three-wheeled scooter of claim 1, wherein a rotation shaft of the front wheel is eccentrically located behind a bottom end of a centerline of the head tube.

3. The improved three-wheeled scooter of claim 1, wherein the handle extends forward from the steering tube.

4. The improved three-wheeled scooter of claim 1, wherein the left and right rear wheels are mounted to the opposite sides of the rear end of the carrier in a mode of non-swing.

5. The improved three-wheeled scooter of claim 1, wherein the carrier comprises left and right carrier poles, a pedal is mounted on each of the left and right carrier poles.

6. The improved three-wheeled scooter of claim 1, wherein the carrier comprises left and right carrier poles, the left and right rear wheels are respectively mounted to rear ends of the left and right carrier poles.

7. The improved three-wheeled scooter of claim 1, wherein the front wheel mounted to the bottom end of the steering tube and the rear wheels mounted to the opposite sides of the rear end of the carrier are substantially arranged in an equilateral triangle.
